(19) United States
(12) Patent Application Publication
(10) Pub. No.: US 2009/0240627 A1
(43) Pub. Date: Sep. 24, 2009

(54) PAYMENT PROCESSING SYSTEM TRUSTED AGENT IDENTIFICATION

(76) Inventors: Hector Javier Rodriguez, Daly City, CA (US); Marc H. Perl, Cameron Park, CA (US)

Correspondence Address: Quarles & Brady LLP, TWO NORTH CENTRAL AVENUE, One Renaissance Square, PHOENIX, AZ, 85004-2391, US

(21) Appl. No.: 12/052,927

(22) Filed: Mar. 21, 2008

(51) Int. Cl. H04L 9/00

(52) U.S. Cl. 705/76

(57) ABSTRACT

Compliance with data security requirements is determined for an agent that processes transactions for merchants. An authorization request received from the agent for a transaction on an account that includes a bank identification number (BIN) licensed to an acquirer and an agent unique account result (AUAR) for the agent. The AUAR is valid when a primary account number (PAN) corresponding to the account and an agent identifier can be derived from the AUAR. The AUAR is invalid when the PAN lacks such correspondence or when the agent identifier lacks uniqueness among other agent identifiers. The acquirer receives the identify of the agent and the BIN when the AUAR is invalid, when the agent isn't registered to use the BIN, and when the agent identifier is invalid. When the agent is not registered to use the BIN, the acquirer will be informed.

### FIELD

Implementations generally relate to payment processing systems, and more particularly to identification of a trusted agent within a payment processing system.

### BACKGROUND

A typical payment processing system services a consumer with a portable consumer device, such as a debit, credit, or pre-paid card or other such device, who makes a purchase with a merchant. The portable consumer device typically has an account number associated therewith and is issued by an issuer such as a bank or other institution. The issuer provides a statement to the consumer for the items purchased, plus any interest and fees, for payment by the consumer. An acquirer makes payment to the merchant for the amount of the purchase, minus any fees, and is in turn paid by the issuer. These transactions occur within the payment processing system which is typically facilitated by a transaction handler, and which also establishes and manages business rules for participants in the payment processing system. The payment processing system can also include processors which receive transaction requests from the merchants and which provide some processing of the transaction to the acquirer and to the payment processing system.

Merchants in a typical payment processing system often engage the services of third party agents without informing their acquirer. These third party agents may perform some value added service relative to the transactions, and may consolidate multiple transactions, and deliver these multiple transactions to processors who are themselves third party agents. While the merchant may be lowering its cost per transaction by using a third party agent, the processor receiving transactions from the third party agent may not be aware of the relationship between the merchant, the third party agent and the acquirer. Acquirers may be unaware of third party agents that are using bank identification numbers (BINs) that are assigned to the acquirer for the acquirer's use. Third party agents who are not registered to use a BIN that is assigned for an acquirer's use are considered to be operating outside of the regulatory and/or business rules of the payment processing system.

Acquirers have the liability for the actions of its sponsored merchants and the third party agents that service the transaction conducted by these merchants. One of the more significant risks to acquirers is the possibility of the third party agent having consumer data stolen. This type of compromise of the third party agent can occur when the consumers' account data us accessed by a malicious hacker, possibly resulting in fraudulent use of the consumers' account data. Third party agents not only might not be registered by any acquirer to use a BIN of an acquirer, the third party agent might also lack even the minimum data security required by a transaction handler in a payment processing system.

Techniques are needed to identify compliance of third party agents with data security requirements of a transaction handler in a payment processing system.

### SUMMARY

Implementations include receiving, from a third party agent, an authorization request for a transaction in a payment processing network. The authorization request includes a bank identification number (BIN) licensed to an acquirer and an agent unique account result (AUAR) for the third party agent. A result is determining as to whether the AUAR is valid or invalid. The AUAR is valid when a primary account number (PAN) and an agent identifier can be derived from the AUAR, where the PAN corresponds to an account of a consumer conducting the transaction with a merchant and the agent identifier is unique within the payment processing network to other agent identifiers respectively corresponding to other said third party agents. The AUAR is invalid when the PAN lacks correspondence to the account of the consumer conducting the transaction with the merchant or when the agent identifier lacks uniqueness within the payment processing network to other agent identifiers respectively corresponding to other third party agents. A result is determined as to whether the third party agent is registered to use the BIN by locating the agent identifier within a registration set containing many agent identifiers each of which has a status of being registered to use the BIN.

The agent identifier can be determined to be valid when it is within a set of agent identifiers and invalid when not within the set. The identification of the third party agent and the BIN will be sent in a transmission to the acquirer when the AUAR is invalid, when the third party agent is not registered to use the BIN, and when the agent identifier is invalid. When the third party agent is not registered to use the BIN, the acquirer will be informed. The transmission will also includes a request to associate the merchant with the agent identifiers each of which has the status of being registered to use the BIN.

In another implementations, an identification is made of at least one third party agent participating in a payment processing system. In a still further implementation, a computer implemented method includes the steps of establishing a security measure compliance for a third party agent; determining what bank identification number is used by a third party agent in the transaction; and informing an acquirer associated with the bank identification number of the third party agent's status relative to the security measure compliance.

In still further implementation, a computer implemented method includes the steps of establishing a registry for third party agents who are compliant with a security measure; assigning an agent unique identifier and a secret code to a third party agent when it is compliant with the security measure; requiring the use of the third party agent unique identifier and a secret code along with a primary account number for the transaction; identifying an agent unique account result from the agent unique identifier and the secret code; requesting that the third party agent transmit the agent unique account result in any authorization request messages sent to an acquiring processor; obligating the acquiring processor to include the agent unique account result in the authorization request messages that have been sent to the acquiring processor by the third party agent; storing the authorization request messages; and periodically reporting to the acquirer all acquiring processors using any bank identification numbers associated with the acquirer that the acquirer has not designated the acquiring processor to use, and all agents using the acquirer bank identification numbers that such agents are not registered in the registry.

In yet another implementation, a transaction handler requests an issuer to obtain payment for a transaction from a consumer who conducted the transaction with a merchant. The merchant uses an acquiring processor and/or a third party agent to submit the transaction to the acquirer. The issuer forwards the payment to the transaction handler who forwards the payment to the acquirer to pay the merchant for the transaction. In this implementation, the third party agent adopts an agent unique identifier and a secret code. A derivation is made of an agent unique account result by the third party agent using the agent unique identifier and the secret code. Alternatively, the acquiring processor can place a reserved agent unique account result in an authorization request for each third party agent who is absent of sponsorship to use a bank identification number associated with the acquirer.

In various implementations, a trusted agent program (TAP) can systematically identify third party agents and the acquirers whose BINs are being used by the third party agent(s). Other implementations validate the registration of an third party agent who submits transactions through an acquiring processor for a given acquiring BIN, where the third party agent is registered with a transaction handler by the acquirer licensing that BIN. Agent registration can require validation of compliance with information security program. Still other implementations identify a merchant whose transactions are being submitted by an unregistered agent, where the transaction handler provides this information to acquirers in monthly reports, and acquirers use reports to identify the agent using its BIN(s). Other implementations enforce operating regulations and business rules of a payment processing system so as to require acquiring processors to provide acquirers with periodic lists of third party agents using those BINs that have been assigned to the acquirer. Still other implementations use the foregoing techniques to validate the relationship among the acquirer, the acquiring processor, the third party agent, and the merchant.

### BRIEF DESCRIPTION OF THE DRAWINGS

Implementations will become more apparent from the detailed description set forth below when taken in conjunction with the drawings, in which like elements bear like reference numerals.

FIG. 1 illustrates a block diagram of an exemplary payment processing system within which implementations corresponding to FIGS. 2-8 may be practiced;

FIGS. 2A-2C, taken together, represent a flowchart of one implementation of an exemplary method conducted within the payment processing system of FIG. 1;

FIG. 3 is a schematic flowchart of an implementation of an exemplary agent setup in an exemplary trusted agent program;

FIG. 4 is a schematic flowchart of an implementation of an exemplary trusted agent program transaction flow;

FIG. 5 is a schematic view of one implementation of an exemplary report for an exemplary trusted agent program;

FIG. 6 is a schematic view of one implementation for the calculation and construction of a Agent Unique Account Result (AUAR);

FIG. 7 is a table view of one implementation which illustrates an exemplary test vectors for the AUAR of FIG. 6; and

FIG. 8 is a schematic view of one implementation which illustrates an exemplary layout for tracks 1 and 2 on a magnetic stripe of a portably consumer transaction device, for example, a credit card, and identifies the placement of a Primary Account Number (PAN).

### DETAILED DESCRIPTION

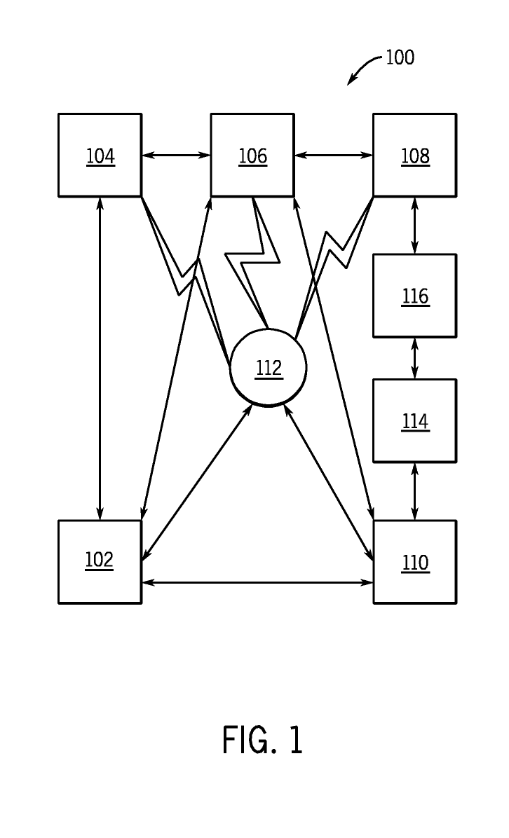

A transaction handler in a payment processing network may receive from a third party agent an authorization request for a transaction. In this case, the transaction is conducted by a consumer with merchant, where the transaction is conducted on an account issued to the consumer by an issuer. An exemplary payment processing system 100 is depicted in FIG. 1 includes an issuer 104; a transaction handler 106, an acquirer 108; a merchant 110; and a consumer 102. The acquirer 108 and the issuer 104, and other entities can communicate through the transaction handler 106. The merchant 110 may utilize at least one Point of Service (POS) terminal that can communicate with the acquirer 108, the transaction handler 106, or the issuer 104. Thus, the POS terminal is in operative communication with the payment processing system 100.

In one implementation, the authorization request received by the transaction handler from the third party agent includes a bank identification number (BIN) licensed to an acquirer and an agent unique account result (AUAR) for the third party agent. The transaction handler determines a result as to whether the AUAR is valid or invalid. The AUAR is valid when a primary account number (PAN) and an agent identifier can be derived from the AUAR, where the PAN corresponds to an account of a consumer conducting the transaction with a merchant and the agent identifier is unique within the payment processing network to other agent identifiers respectively corresponding to other said third party agents. The AUAR is invalid when the PAN lacks correspondence to the account of the consumer conducting the transaction with the merchant or when the agent identifier lacks uniqueness within the payment processing network to other agent identifiers respectively corresponding to other third party agents. The transaction handler determines a result as to whether the third party agent is registered to use the BIN by locating the agent identifier within a registration set containing many agent identifiers each of which has a status of being registered to use the BIN. The agent identifier can be determined to be valid when it is within a set of agent identifiers and invalid when not within the set. The identification of the third party agent and the BIN will be sent in a transmission to the acquirer when the AUAR is invalid, when the third party agent is not registered to use the BIN, and when the agent identifier is invalid. When the third party agent is not registered to use the BIN, the acquirer will be informed. The transmission will also includes a request to associate the merchant with the agent identifiers each of which has the status of being registered to use the BIN.

Implementations include a Trusted Agent Program (TAP). In the TAP implementations, a fraud reduction measure focuses on identifying all third party agents participating in a payment system. TAP can reduce payment risk by identifying participants in the payment system and requiring these entities to validate compliance with an information security program, such as the Cardholder Information Security Program (CISP) of Visa Inc. located in San Francisco, Calif., USA. TAP accomplishes this goal, at least in part, by requiring all agents 114 to uniquely identify each authorization request.

Some of TAP's advantages of at least one implementation include: identify all agents 114 operating in the payment system 100; assist acquirers 108 to identify agents 114 that are using its BINs and to assure that all agents 114 using these BINs are registered by that acquirer 108; assist acquiring processors 116 and agents 114 to comply with operating regulations that requires acquiring processors 116 to provide periodic reports to their acquirer clients and the transaction handler 106 on the use of acquirer BINs by agents 114; provide a competitive advantage to the agents 114 that participate and validate CISP compliance; CISP compliant registered agents 114 are resident the transaction handler's 106 list of compliant providers which is also available via website access; provide a competitive advantage to acquiring processors 116 that participate in TAP, acquirers 108 want to do business with acquiring processors 116 that can identify all agents 114 connected to them; protect the payment processing system by having all participants validate compliance with the Cardholder Information Security Program (CISP), where the CISP validation significantly reduces the risk of compromise; increase cardholder 102 confidence by lowering the incidence of compromise at agents participating in the payment processing system 100, lowering the risk of compromise results in increased volume and profitability for all participants; “level the field” for those agents 114 that are registered and CISP compliant by requiring all agents 114 identified through TAP to be fully registered and CISP compliant.

TAP accomplishes these goals by systematically identifying and reporting unregistered agents to acquirers whose BINs are being used by the agent. Acquirers receive monthly reports identifying unregistered agents using their BINs. For the purposes of this discloser, an acquirer is a member that signs a merchant or disburses currency to a cardholder in a cash disbursement, and directly or indirectly enters the resulting transaction receipt into the payment system process interchange. An acquirer is a payment system financial institution that contracts with merchants to accept the payment system portable device for payment of goods or services. An acquirer may also contract with agents and acquiring processors to process these merchant originated transactions. Acquirers receive monthly TAP reports from the transaction hander that identify agents using the acquirer's BINs that the acquirer has not registered or whose transactions do not conform to the Agent Unique Account Result (AUAR) specification. A processor (acquiring processor) is a member of the payment processing system 100, or the transaction handler, or a transaction handler-approved nonmember acting as the agent of a member, that provides authorization, clearing or settlement services for merchants and members. Processors are directly connected to network which is part of payment processing system 100.

By way of example, a transaction begins with the consumer 102 presenting account number of the account such as through the use of a computer terminal or a portable consumer device 112 to the merchant 110 to initiate an exchange for a good or service. The consumer 102 may be an individual or a corporate entity. The consumer 102 may be an account holder of the account issued by the issuer 104 such as a joint account holder of the account or a person having access to the account such as an employee of a corporate entity having access to a corporate account. The portable consumer device 112 may include a payment card, a gift card, a smartcard, a smart media, a payroll card, a health care card, a wrist band, a machine readable medium containing account information, a keychain device such as the SPEEDPASS® commercially available from ExxonMobil Corporation or a supermarket discount card, a cellular phone, personal digital assistant, a pager, a security card, a computer, an access card, a wireless terminal, or a transponder. The portable consumer device 112 may include a volatile or non-volatile memory to store information such as the account number or a name of the account holder.

The merchant 110 may use an acceptance point device, such as a POS terminal, to obtain account information, such as the indicator for the account (e.g., the account number of the account), from the portable consumer device 112. The portable consumer device 112 may interface with the POS terminal using a mechanism including any suitable electrical, magnetic, or optical interfacing system such as a contactless system using radio frequency, a magnetic field recognition system, or a contact system such as a magnetic stripe reader. The POS terminal sends a transaction authorization request to the issuer 104 of the portable consumer device 112. Alternatively, or in combination, the portable consumer device 112 may communicate with the issuer 104, the transaction handler 106, or the acquirer 108.

The issuer 104 may authorize the transaction using the transaction handler 106. Authorization includes the issuer 104, or the transaction handler 106 on behalf of the issuer 104, authorizing the transaction in connection with instructions of the issuer 104, such as through the use of business rules. The business rules could include instructions or guidelines from the transaction handler 106, the consumer 102, the merchant 110, the acquirer 108, the issuer 104, a financial institution, or combinations thereof. The transaction handler 106 may maintain a log or history of authorized transactions. Once approved, the merchant 110 can record the authorization and allow the consumer 102 to receive the good or service.

The merchant 110 may, at discrete periods, such as the end of the day, submit a list of authorized transactions to the acquirer 108 or other components of the payment processing system 100. The transaction handler 106 may compare the submitted authorized transaction list with its own log of authorized transactions. If a match is found, the transaction handler 106 may route authorization transaction amount requests from the corresponding acquirer 108 to the corresponding issuer 104 involved in each transaction. Once the acquirer 108 receives the payment of the authorized transaction amount from the issuer 104, it can forward the payment to the merchant 110 less any transaction costs, such as fees. If the transaction involves a debit or pre-paid card, the acquirer 108 may choose not to wait for the initial payment prior to paying the merchant 110.

There may be intermittent steps in the foregoing process, some of which may occur simultaneously. For example, the acquirer 108 can initiate the clearing and settling process, which can result in payment to the acquirer 108 for the amount of the transaction. The acquirer 108 may request from the transaction handler 106 that the transaction be cleared and settled. Clearing includes the exchange of financial information between the issuer 104 and the acquirer 108 and settlement includes the exchange of funds.

The transaction handler 106 can provide services in connection with clearing and settlement of the transaction. For example, the clearing and settlement of the transaction that involves credit may occur after the authorization of the transaction. The settlement of the transaction involves an issuer 104 withdrawing an amount of a transaction settlement from a clearinghouse, such as an issuer clearing bank, for deposit into a settlement house, such as a settlement bank. The transaction handler 106 deposits the amount of the transaction settlement into an acquirer clearing bank. The corresponding acquirer 108 withdraws the amount of the transaction settlement from the acquirer clearing bank. Typically, the issuer 104 chooses the issuer clearing bank, the transaction handler 106 chooses the settlement bank, and the acquirer chooses the clearing bank. When the transaction involves debit, the clearing may occur during the authorization process. Thus, a typical transaction involves various entities to request, authorize, and fulfill the processing of the transaction for clearing and settlement.

Additionally, the payment processing system 100 can include third party agents 114 and/or processors 116 which may provide value added services for merchant 110 such as consolidating purchases made at merchant 110 for submission to acquirer 108.

The Trusted Agent Program according to the disclosed implementations (TAP) includes a fraud reduction measure focused on identifying all third party agents participating in a payment system. TAP can reduce payment risk by identifying participants in the payment system and requiring these entities to validate compliance with an information security program, for instance the Cardholder Information Security Program (CISP) of Visa Inc. of San Francisco, Calif., USA. TAP accomplishes this goal, at least in part, by requiring all third party agents 114 to uniquely identify each authorization request.

Some of TAP's advantages of at least one implementation include: identify all agents 114 operating in the payment system 100; assist acquirers 108 to identify agents 114 that are using its BINs and to assure that all agents 114 using these BINs are registered by that acquirer 108; assist acquiring processors 116 and agents 114 to comply with operating regulations by requiring acquiring processors 116 to provide periodic reports to their acquirer clients and the transaction handler 106 on the use of acquirer BINs by agents 114; provide a competitive advantage to the agents 114 that participate by validating their CISP compliance; CISP compliant registered agents 114 are resident within the transaction handler's 106 list of compliant providers which is also made available via website access; provide a competitive advantage to acquiring processors 116 that participate in TAP in that acquirers 108 prefer to do business with acquiring processors 116 that can identify all agents 114 connected to them; protect the payment processing system by having all participants validate compliance with an information security program such as the CISP, where such validation significantly reduces the risk of compromise; increase cardholder 102 confidence by lowering the incidence of compromise at agents participating in the payment processing system 100, where the lowering the risk of compromise results in increased volume and profitability for all participants; “level the field” for those agents 114 that are registered and are compliant with an information security program (i.e., CISP) by requiring all agents 114 identified through TAP to be fully registered and compliant with an information security program (i.e., CISP).

TAP accomplishes the foregoing goals by systematically identifying and reporting unregistered agents to acquirers whose BINs are being used by the agent. Acquirers receive monthly reports identifying unregistered agents using their BINs. As used in the Detailed Description, an acquirer is a member that signs a merchant or disburses currency to a cardholder in a cash disbursement, and directly or indirectly enters the resulting transaction receipt into the payment system process interchange. An acquirer is a payment system financial institution that contracts with merchants to accept the payment system portable device for payment of goods or services. An acquirer may also contract with agents and acquiring processors to process these merchant originated transactions. Acquirers receive monthly TAP reports from the transaction hander that identify agents using the acquirer's BINs that the acquirer has not registered or whose transactions do not conform to the Agent Unique Account Result (AUAR) specification. A processor (acquiring processor) is a member of the payment processing system 100, or the transaction handler, or a transaction handler-approved nonmember acting as the agent of a member, that provides authorization, clearing or settlement services for merchants and members. Processors are directly connected to network which is part of payment processing system 100.

The following types of processors are exemplary: an authorizing processor, a clearing processor, an offshore processor, and an important system user. However, this list is not exclusive and other types of processors are possible. This disclosure specifically addresses the acquiring processors that conduct authorization activity.

An agent is any contractor, including processors and any independent sales organization, or third party services whether a member or nonmember, engaged by a member of the payment processing system 100 to provide services or act on its behalf in connection with the payment processing system 100. Agents include card processors that are not directly connected to transaction handler/network but deliver transactions to acquiring processors for transmission to the transaction handler. Agents include both third party servicers (TPS) and merchant servicers (MS). For the purposes of this disclosure, both TPSs and MSs will be referred to as agents.

Implementation provide for authorization request messages which have been enhanced to provide a data field that is populated by acquiring processors with an Agent Unique Account Result (AUAR). All agents that deliver authorization transactions to a processor are required to provide the Agent Unique Account Result (AUAR) in all authorization requests. Acquiring processors populate a specific field with AUAR when an authorization request is received from an agent. The AUAR can be a 12-byte field constructed by the agent for each authorization request. The AUAR can be constructed by concatenating:

A 1 digit length byte;

A 5 digit unique identifier, called the Agent Unique Identifier, assigned by the transaction handler to each agent;

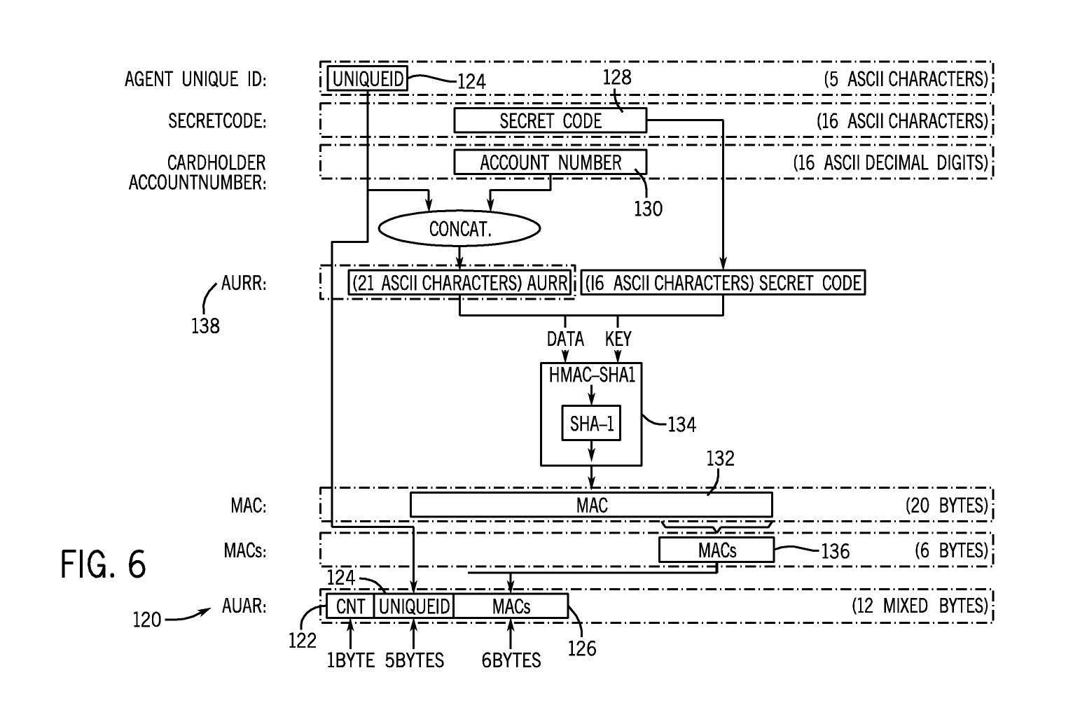

The least significant 6 bytes (48 binary bits) of the resultant of a cryptographic algorithm called HMAC-SHA1 (schematically on FIG. 6 at 134). HMAC-SHA1 is a cryptographic, keyed-Hash Message Authentication Code, or HMAC, which is a type of message authentication code (MAC) calculated using a cryptographic hash function in combination with a secret key or code. The HMAC-SHA1 may be used to simultaneously verify both the data integrity and the authenticity of a message. Any iterative cryptographic hash function, such as MD5 or SHA-1, may be used in the calculation of an HMAC, and the resulting MAC algorithm can be termed HMAC-MD5 or HMAC-SHA1 (also referred to as HMAC-SHA-1) accordingly. At least one measure of the cryptographic strength of the HMAC depends upon the cryptographic strength of the underlying hash function, on the size and quality of the key, and the size of the hash output length in bits.

Agents are encouraged to utilize publicly available sources for code to implement the HMAC-SHA1 calculation. A description of AUAR, its structure and its calculation is described in more detail below.

At month end, the transaction handler validated each authorization request by validating several factors in the transaction. Validation factors can include:

Validating the Agent Unique Identifier;

Validating AUAR;

Validating that the agent is registered to use the acquirer's BIN(s).

Those transactions that fail validation are reported to the acquirer whose BIN was used in the request. The TAP periodic reports are sent to the acquirer or the acquirer's designate. If an agent does not supply an AUAR in an authorization request, the acquiring processor must place a reserved value in the authorization request. Transaction handler 106 can interpret this reserved value and inform the acquirer that an unknown agent is doing business with the acquirer's merchant. These instances are reported in periodic transaction handler reports sent to the acquirer.

It is desired that acquiring processors have the capability of determining when an authorization request is sent to the acquiring processor by an agent as opposed to a merchant. TAP has been designed to allow all agents that process an authorization transaction to participate in TAP. Authorization requests may be processed by more than one agent. TAP has the capability for each agent that processes an authorization request to provide AUAR.

Implementations of TAP can require that only the agents that are directly connected to the transaction handler processors must participate. Other implementations of TAP expand the number of potential AUARs that must be delivered to transaction handler/network. The use of multiple AUARs can be rolled out after the stages of implementation of TAP.

Processors and agents can be made aware of TAP's potential impact. Authorization requests may contain multiple AUARs. When required by the transaction handler, agents may be receiving AUARs from other agents and may be required to transmit these with the authorization request. Processors must also be prepared to transmit multiple AUARs for a single authorization request.

Exemplary TAP Implementation

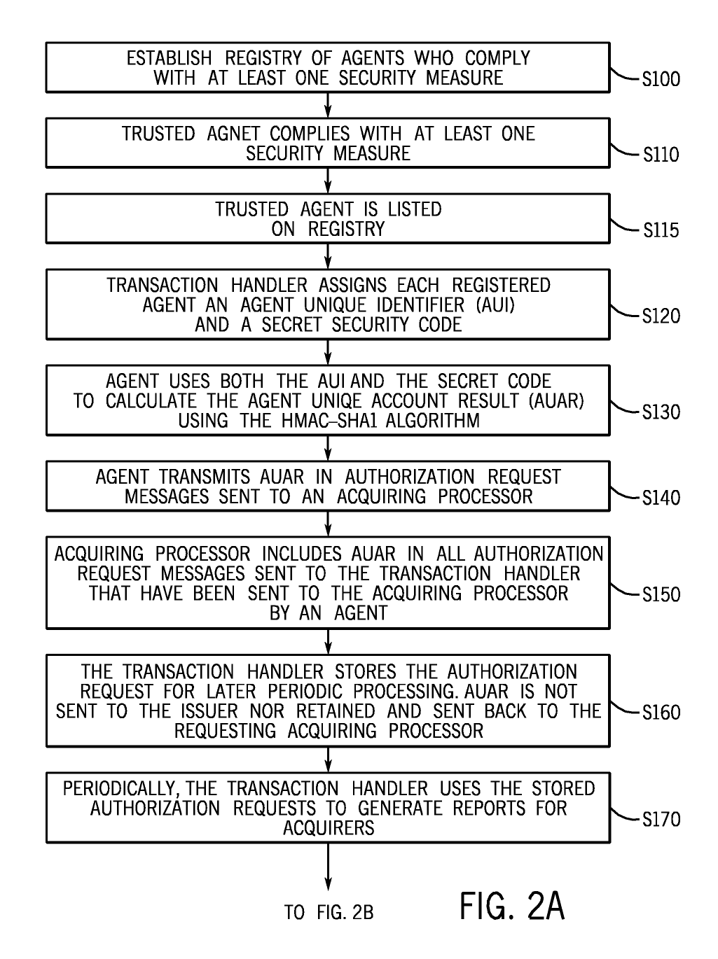

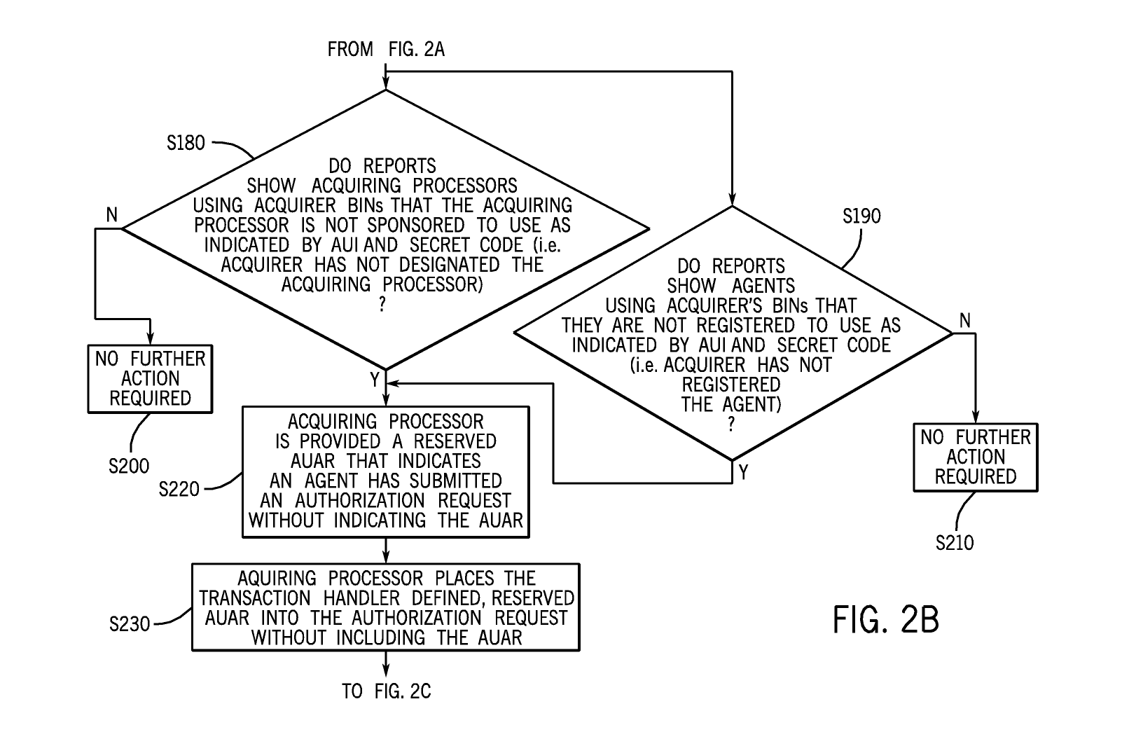

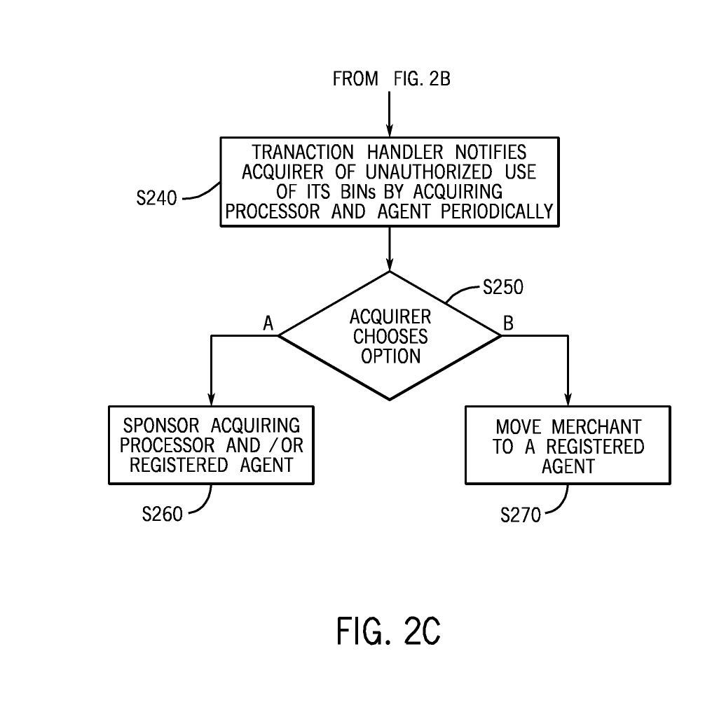

TAP can operate by having the agent provide a calculated value based on data provided to the agent by the transaction handler and data unique to the transaction itself. Referring now to FIGS. 2A-2C, a discussion will be had of how one exemplary implementation of TAP operates. In step S100, a registry is established with at least one security measure requirement for agents in the registry. When an agent complies with the security measure(s) in step S110, step S115 lists the trusted agent in the registry and step S120 has the transaction handler assign each registered agent an Agent Unique Identifier (AUI) and a secret code (i.e., a numerical code). In step S130, the agent uses both the AUI and the secret code, along with the primary account number for the transaction, to calculate the Agent Unique Account Result (AUAR) using the HMAC-SHA1 algorithm or an algorithm that is substantially a HMAC-SHA1 algorithm.

In step S140, the agent transmits AUAR in all Authorization Request messages sent to an acquiring processor. In step S150, the acquiring processor is required to include AUAR in all Authorization Request messages sent to the transaction handler that have been sent to the acquiring processor by an agent. The transaction handler stores the Authorization Request for later monthly processing. AUAR is not typically sent to the issuer nor retained and sent back to the requesting acquiring processor, in step S160. In step S170, the transaction handler periodically (every month or other intervals) uses the stored Authorization Requests to generate reports for acquirers that show: (S180) all acquiring processors using acquirer BINs that the acquiring processor is not sponsored to use (i.e. the acquirer has not designated the acquiring processor), and/or (S190) all agents using acquirer's BINs that they are not registered to use (i.e. the acquirer has not registered the agent).

If the reports do not indicate unsponsored acquiring processors nor unregistered agents then no further action is required per steps S200 or S210, respectively. Otherwise, agents that are not registered by any acquirer have not been provided an Agent Unique Identifier nor a secret code by the transaction handler. The acquiring processor is provided with a reserved AUAR (S220) that indicates an agent has submitted an Authorization Request without including the AUAR. In step S230, the acquiring processor places the transaction handler defined, reserved AUAR into the Authorization Request when the agent does not supply an AUAR.

The transaction handler notifies the acquirer in step S240 of unauthorized use of its BINs by acquiring processors and agents on a monthly basis. The acquirer also needs to choose (S250) either: (S260) sponsor the acquiring processor and/or register the agent, or (S270) move the merchant to registered agent.

Tap Operation

In one implementation, TAP operates in two steps: 1) an agent is registered with the transaction handler by an acquirer (see TAP agent set up below), and 2) TAP operates and identifies agents participating in the payment processing system 100 and informs acquirers of agents using the acquirer's BINs without being registered by that acquirer. (See TAP transaction flow below)

Tap Agent Set Up

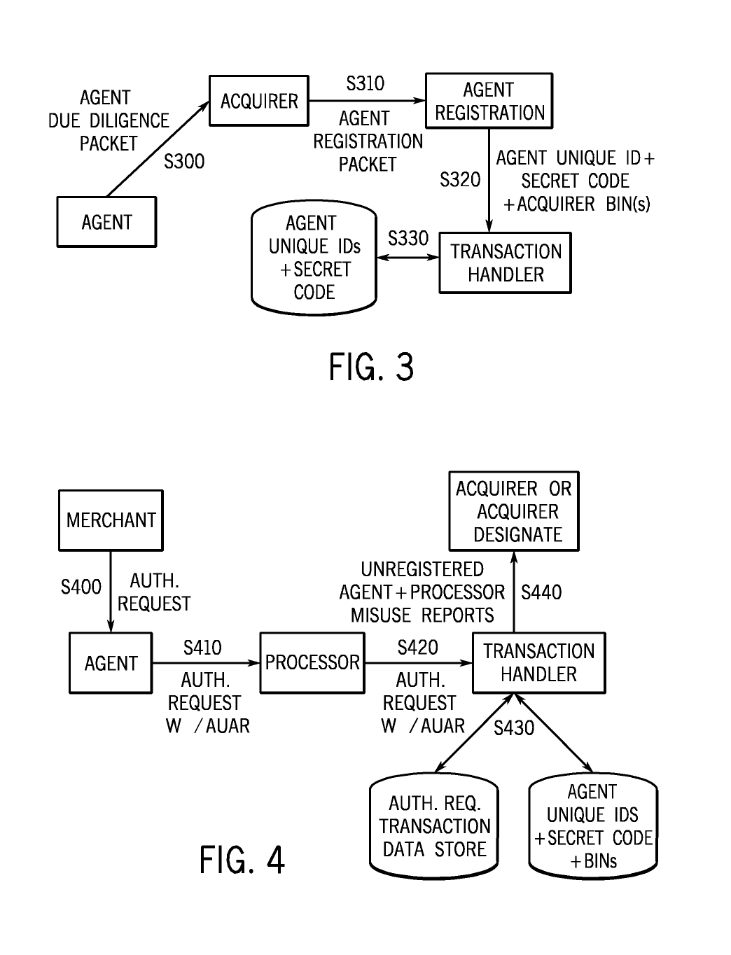

Referring now to FIG. 3, an acquirer notes that an agent is using it's BINs. The acquirer has not registered the agent. The acquirer requests (step S300) a due diligence packet from the agent. Agent registration requires validation of compliance with Cardholder Information Security Program (CISP). The acquirer conducts due diligence and assembles an agent registration packet (step S310) that is submitted to the transaction handler. Upon acceptance of agent registration, the transaction handler assigns an Agent Unique Identifier and Secret Code to the now registered agent. The Agent Unique Identifier and Secret Code are distributed to the agent, in step S320. The agent is required to secure the Secret Code in the same manner as an encryption key. (The agent uses these values to calculate the Agent Unique Account Result (AUAR) that is included with all authorization request messages.) All acquirer BINs that the agent uses are associated with the Agent Unique Identifier and the secret code, in step S330. This data is inserted into the TAP data store at transaction handler network.

Tap Transaction Flow

Referring now to FIG. 4, the merchant sends an authorization request to a registered agent in step S400. The registered agent calculates AUAR and inserts AUAR in the authorization request message sent to the acquiring processor in step S410. The acquiring processor populates the new VIP authorization request message field with the AUAR in step S420. The transaction handler stores the Authorization Request in step S430; and in step S440 the transaction handler produces monthly reports of agent(s) using BIN(s) that the agent is not registered to use. The transaction handler also identifies acquiring processors not sponsored by the acquirer and therefore not authorized to use the acquirer's BINs. The TAP reports are provided to the acquirer or acquirer's designate. Acquirers must: a) either register the agent or move the merchant's business away from the agent; or b) either sponsor the acquiring processor or move the merchant from that acquiring processor.

Acquirer Implementation

The Trusted Agent Program (TAP) informs acquirers of unregistered agents (including third-party servicers and merchant servicers) submitting transactions to the transaction handler's network using the acquirer's BINs. Unauthorized transaction handler's network access compromises the security of the payment processing system 100 and exposes the transaction handler to risk from fraud. Although acquirers are financially liable for all transactions submitted under their BINs, they are often unaware of merchant-agent arrangements because the acquirer's merchants have engaged an agent and have not informed the acquirer.

TAP greatly reduces the acquirer's risk by monitoring transactions submitted through acquiring agents to the transaction handler and then reporting unauthorized use of BINs to acquirers. Recognition of agents using acquirers' BINs provides a new tool for acquirers to manage their merchants and agents.

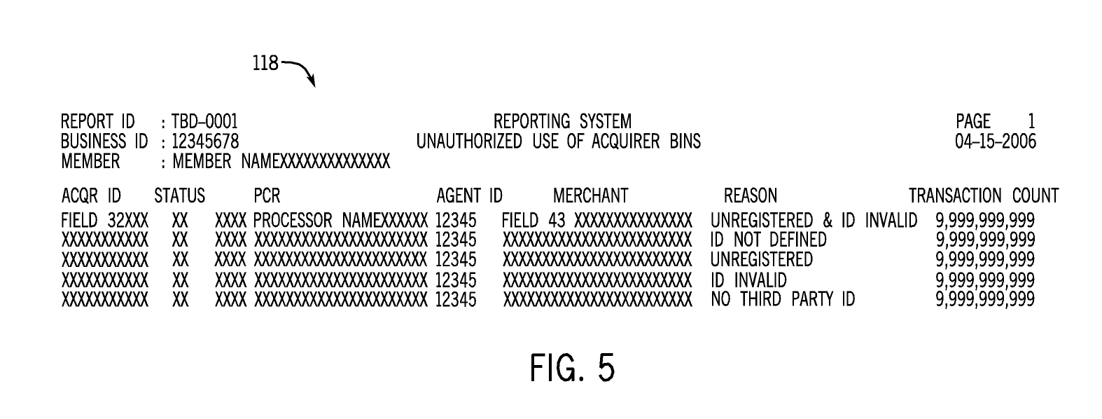

By design, TAP reporting can be provided monthly to acquirers. See FIG. 5 for one implementation of such a report. The TAP reports can be e-mailed to the acquirer's designate. TAP assists the acquirer to manage their business by at least: a) identifying agents that use their BINs without the acquirer having registered the agent, b) specifying the merchant(s) that employs the agent using the acquirer's BINs, c) informing the acquirer of all acquiring processors using their BIN(s).

The TAP report 118 (see FIG. 5 for example) relates merchants and the agents that process the merchant transactions and includes reference to the acquiring processor that submitted the transactions to the transaction handler's network.

Acquirer's Responsibilities

The TAP Report 118 (i.e., see FIG. 5) provides acquirers with information that allows them to associate a merchant with an agent and identifies the acquiring processor that submitted the authorization request to transaction handler's network. One implementation of a sort sequence is as follows: MEMBER (Member Name), ACQR ID (BIN), PCR, AGENT ID (Third Party), MERCHANT, REASON; with a Page Break: Member (Member Name).

In FIG. 5, the following descriptions for the report field labels are as follows: BUSINESS ID—the unique identification number assigned to a business; MEMBER—the name of the Member institution; ACQR ID—the acquiring institution identification code used to identify the financial institution acting as the acquirer of a transaction. This could be the acquirer's code or that of an agent acting on behalf of the acquirer; STATUS—indicates whether the BIN is assigned, reserved, or recalled; PCR—the code and name of the processor acting on behalf of the acquirer; AGENT ID—the code (AGENT Unique ID) used to identify AGENTs that submit POS transactions to the transaction handler; MERCHANT—the name of the card acceptor (Merchant name); REASON—the reason this group of transactions failed TAP compliance tests; TRANSACTION COUNT—the number of transactions for the set uniquely identified by the other values in the same row.

The TAP report is generated periodically, for example monthly (or at other intervals, or on request) at the beginning of each month for transactions occurring in the previous month. All entries on the TAP report require action on the part of the acquirer. Each line on the report is specific to a Merchant Name as submitted to the transaction handler in the authorization request and transaction counts are for that Acquirer—Agent—Merchant Name only for the previous month.

Acquirers can review the monthly report and identify agents using its BINs that have not been registered by the acquirer. The REASON column of the TAP report has five possible statuses: 1) NO THIRD PARTY ID—Assigned when the acquiring processor knows that the authorization request has come from an agent, but the agent has not provided an AUAR. The acquiring processor will populate the authorization request with a default value provided by the transaction handler. 2) UNREGISTERED—Assigned when the AUAR is valid, but the acquirer BIN is not present on the list of registered acquirer BINs for the agent. 3) ID INVALID—Assigned when the AUAR is not valid, but the acquirer BIN is present on the list of registered acquirer BINs for the agent. 4) UNREGISTERED & ID INVALID—Assigned when the AUAR is present but not valid, and the acquirer BIN is not present on the list of registered acquirer BINs for the agent. 5) ID NOT DEFINED—Assigned when the Agent Unique Identifier (part of the AUAR) is not valid.

Acquirers can take action based on the status indicated on the TAP report. Actions taken may be to register the agent or to move the merchant to a registered agent. Acquirers must also validate that that the acquiring processor specified in the TAP report is designated by the acquirer. If an acquirer has yet to designate the acquiring processor that processed the transaction, the acquirer can file an exhibit with the transaction handler. The name of the transactions' acquiring processor is found in the PCR column of the report.

Acquiring Processor Implementation

Unauthorized access to a transaction handler's network compromises the security of the payment processing system 100 and exposes member of the payment process system 100 to risk from fraud. Although acquirers are financially liable for all transactions submitted under its BINs, they are often unaware of merchant-agent arrangements because merchants fail to inform their acquirer of a relationship with an agent. Many acquirers outsource the processing of merchant transactions. Since the transactions bypass the acquirer, the acquirer may not be aware of all agents using its BINs.

TAP provides a management tool to the acquiring processor to manage its relationships with agents and to assist the acquiring processors with compliance with operating regulations and other business rules for payment processing system 100. TAP reduces the acquirer's risk by monitoring transactions submitted through acquiring agents to payment processing system 100 and then reports unauthorized use of BINs to acquirers. Unregistered agents are identified and logged for acquirer registration and the transaction handler's risk analysis.

Acquiring Processor Responsibilities

Referring now to FIG. 6:

1. Develop the capability of identifying all agents that communicate with the acquirers system. Acquiring processors must be able to distinguish between authorization requests coming directly from a merchant and those that have been transmitted to the acquiring processor by an agent. Payment processing system 100 authorization request messages can be properly formatted depending upon the source of the authorization request: i.e., those from an agent must contain AUAR 120 (FIG. 6), those from a merchant must not. Merchants are not permitted to provide the Agent Unique Account Result (AUAR). AUAR is not present in authorization requests transmitted to an acquiring processor directly from a merchant.

2. Enhance the authorization request message format from agents to include the Agent Unique Account Result (AUAR). Acquiring processors can make allowances in their proprietary authorization request message formats for agents to transmit the 12 byte AUAR in authorization requests.

3. Certify each agent's compliance with the enhanced authorization format. Acquiring processors typically require all agents to certify compliance with their message format. Once an acquiring processor has enhanced their authorization request format to account for AUAR, the acquiring processor must certify all agents that transmit authorization requests.

4. Develop support for the report field, AUAR. Each acquiring processor must support a field in a transaction system report. If an authorization request is transmitted to an acquiring processor by an agent, the acquiring processor must populate a field in the authorization request messages. This field is called the Agent Unique Account Result (AUAR). AUAR is a 12 byte field composed of 3 sub-fields. The data format (i.e. ASCII, BCD, etc.) of the first two sub-fields delivered by an agent is acquiring processor selected. The acquiring processor should not alter the value in the third sub-field provided by the agent.

Sub-field 1 (122): Length byte. This is set to 1 for this implementation of TAP.

Sub-field 2 (124): The agent's 5 byte Agent Unique Identifier. This value is supplied to the agent by transaction handler and must be included in all authorization requests.

Sub-field 3 (126): The least significant 48 bits (6 bytes) of binary data from the resultant of the Agent Unique Account Result calculation. This data remains unchanged from the result of the agent's HMAC-SHA1 calculation. It is delivered to transaction handler exactly as provided to the acquiring processor by the agent.

When composing requests to the transaction processor, the acquiring processor must format the AUAR according to Table 1 and place the AUAR into a field in the report.

TABLE 1
Agent Unique Account Result (AUAR)

Field Number
Field Name
Agent Unique Account Result
Format
Variable length
1 byte binary
+5 bytes of EBCDIC
+6 bytes (48 bits) binary bit string;
12 bytes total
Value
A character string that consists of agent-specific data and
result of the hashing algorithm.

### DESCRIPTION

A unique identifier that will indicate that the message was sent from an agent

5. Certify to use the transaction field with transaction handler. Acquirers and their acquiring processors must support the Trusted Agent Program. Acquiring processors must certify with transaction handler to utilize the transaction field. The transaction handler has installed TAP in a payment processing system certification management system (CMS) to provide processors with the opportunity to test their implementation of TAP.

The transaction field is not sent to the issuer processor nor is it returned in the authorization response. The field in the report can be validated off-line by the transaction handler. Monthly TAP reports detailing agents that require registration are sent to the acquirer or the acquirer's designate.

6. Insert a default AUAR into the transaction handler authorization request when the transaction came from an agent, but no AUAR was supplied.

If acquiring processor receives an authorization request from an agent but the AUAR is not included, the acquiring processor must use a transaction handler supplied default AUAR for the payment processing system 100 submission. The default AUAR can be:

Sub-field 1: Set to binary 1

Sub-field 2: Set to EBCDIC 99999

Sub-field 3: Set to hexadecimal ffffffffffff

7. Populate the AUAR field

Acquiring processors are required to develop the capability of receiving the AUAR from agents. All authorization request messages from agents can include the AUAR. Processors can have the capability of receiving an agent calculated AUAR and placing this value in a field of the report. If an acquiring processor receives requests directly from a merchant, the AUAR field must not be present in the authorization request sent to the transaction handler.

8. Provide testing assistance to agents

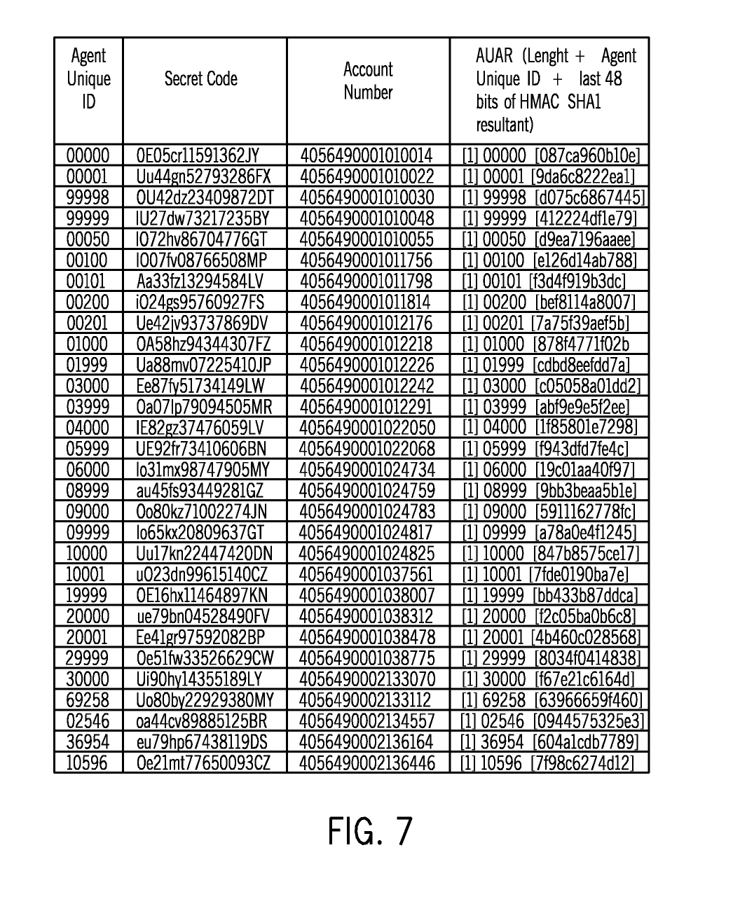

Agents may require assistance while testing their implementation of TAP. A set of test vectors for the validation of the HMAC-SHA-1 calculation is shown in FIG. 7. Since VCMS is available, validation of the processors' and the agents' implementation is available.

Agent Implementation

Agent Role

Agents play a critical role in securing the payment processing system 100. Agents must be CISP compliant in order to protect the interests of the agent, acquirer and merchant clients. Since agent registration requires validation of CISP compliance, the transaction handler 106 can require that all participants in payment processing system 100 identify themselves and be registered by all acquirers whose BINs are used by the agent.

TAP provides the opportunity for all agents to participate in the payment system as registered entities. Registration and CISP compliance have become a way for acquirers, acquiring processors and merchants to validate the safety and soundness of an agent. Agents that are CISP compliant can note that their growth has increased due to their CISP status. All CISP compliant service providers can be listed on a list of CISP Compliant Service Providers.

TAP provides a way for agents to identify themselves and position themselves in payment processing system 100. Agents that do not participate can be recognized by TAP and can be contacted by acquirers whose BINs are being used. Becoming a Trusted Agent can require the following: a) be registered with the transaction handler by at least one acquirer; b) validate compliance with the Cardholder Information Security Program (CISP); and c) participate in the Trusted Agent Program.

Agent Responsibilities

Agents responsibilities include, but are not limited to, the following.

1. Responding to requests for registration from acquirers. On a monthly basis, the transaction handler 106 supplies acquirers with TAP reports. The TAP report delineates agents not yet registered by the acquirer. The acquirer registers these agents. The registration process requires the acquirer to conduct due diligence on the agent. Acquirers that need to register an agent request due diligence packages from the agent. There are at least two cases: a) An agent is registered by another acquirer(s). In this case, the agent should have a due diligence package that has been provided to other acquirers; and b) the agent has yet to be registered by any payment processing system member. In this case, the acquirer will provide the requirements for due diligence to the agent. The agent assembles the due diligence package and provide the package to the requesting acquirer.

Registration is the first step in becoming a Trusted Agent. All registered agents must validate Cardholder Information Security Program (CISP) compliance.

2. Assign an individual to be the agent's transaction handler liaison. Once an agent has provided the due diligence package to the acquirer, and the acquirer has reviewed and approved the package, the acquirer registers the agent with the transaction handler. The transaction handler contacts the agent for the assigned liaison's contact information. All agents, including those presently registered, are required to provide liaison contact information to the transaction handler 106.

3. Receive the Secret Code (i.e., a numerical code) and Agent Unique Identifier and protect both pieces of data. Once an agent is registered by at least one acquirer, the transaction handler can e-mail the following data to the agent's assigned transaction handler's contact via a secure e-mail facility:

Agent Unique Identifier—This value can be 5 digits. This value is the lower order 5 digits of the agent's Business Identifier (BID).

Secret Code (numerical code)—This value can be 16 characters and can contain lower and upper case letters and numbers. It is randomly generated by the transaction handler and is unique to the agent.

The data can be used in all authorization requests independent of the acquiring processor to whom the request is sent. Each agent is expected to protect this data as unique to the agent. The Secret Code should be protected as one would protect an encryption key.

The transaction handler 106 can provide this data to all currently registered agents as required. When a new agent is registered, the agent can be provided with both pieces of data. Once an agent has received both pieces of data, and the agent has certified with the acquiring processor(s), the agent can begin to transmit AUAR to the payment processing system 100 processor(s).

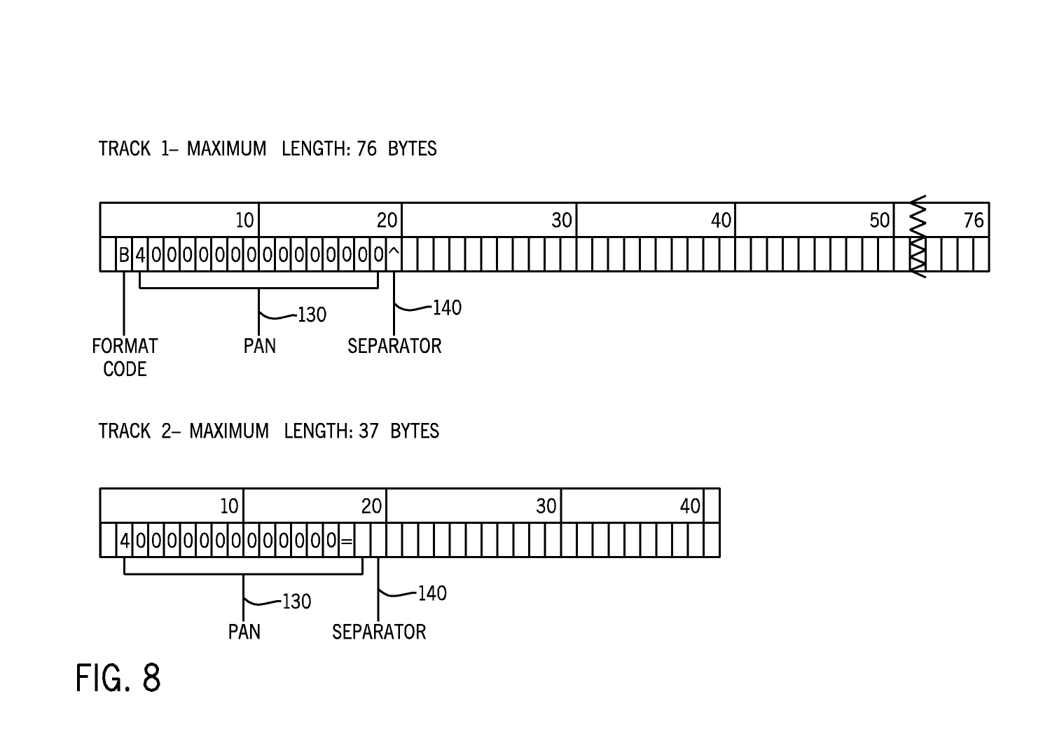

4. Develop and test the capability to isolate the Primary Account Number used in each authorization request. Agents can be required to isolate the primary account number (PAN) for each authorization request. In the case of card present transactions, the PAN may need to be parsed from the full track sent with the authorization request. In card not present authorization requests (e.g. Mail Order-Telephone Order, e-commerce), track data may not be present. The PAN may need to be extracted from the proprietary format of the merchant's authorization request. FIG. 8 contains the layout for tracks 1 and 2 and identifies the placement of the PAN. Agents may need to develop the capability of isolating the PAN and using it in the calculation of AUAR.

5. Utilize the Agent Unique Identifier, the Primary Account Number and the Secret Code to calculate the AUAR. The calculation of Agent Unique Account Result (AUAR) requires the following data:

Primary Account Number 130

Agent Unique Identifier 124

Secret Code 128

An explanation of the calculation of AUAR is given below. The same explanation also contains a set of test vectors that provide agents with the capability of validating the HMAC-SHA-1 calculation and the construction of the required field.

The layout of both track 1 and track 2 identifying the placement of the PAN is given in FIG. 8 and described below. The graphics show the position of a 16 digit PAN. It is possible to receive PANs of 13, 16 and 19 digits, although the vast majority can be 16 digits.

The twelve byte AUAR can be composed of 3 sub-fields:

Sub-field 1: A length byte. This can always be, or typically be, set to 1.

Sub-field 2: The agent's 5 byte Agent Unique Identifier. This value is supplied to the agent by the transaction handler 106 and included in all authorization requests.

Sub-field 3: The least significant 48 bits (6 bytes) of binary data from the resultant of the HMAC-SHA-1 calculation. This data must remain unchanged from the result of the HMAC-SHA1 calculation.

Sub-field 3 of the AUAR is a calculated value that uses the HMAC-SHA1 algorithm. The explanation of the calculation of sub-field 3 is found in below.

Sources for HMAC-SHA1 code have been previously described and test vectors that must be used to validate the agent's implementation of AUAR. The use of available code to calculate sub-field 3 of the AUAR is strongly recommended. Sources of available HMAC-SHA-1 code have been previously described.

6. Certify with all acquiring processors to whom they are connected. Agents deliver authorization requests to acquiring processors. Since the acquiring processor may have to enhance the proprietary format of their authorization request, the agent must certify with all acquiring processors to whom they are connected. Agents may contact the acquiring processors that they are connected to for details of enhancements to their proprietary message format and for instructions for certification.

7. Insert the AUAR into all authorization request messages. When an agent has successfully certified with the acquiring processor(s) and has validated the calculation of AUAR, the agent is ready to participate in TAP.

Agents must supply a new value to acquiring processors for each authorization request processed by the agent. This value is called the Agent Unique Account Result (AUAR). The AUAR is forwarded to the acquiring processor along with the required information presently required by the acquiring processor. The acquiring processor can submit the authorization request to the transaction handler 106.

Implementation of Agent Unique Account Result (AUAR)

AUAR Description

The Agent Unique Account Result (AUAR) is a value that is unique for each authorization request transaction. AUAR is calculated by an agent and used by transaction handler 106 to validate that an agent is registered and performing agent duties as required by the transaction handler's 106 operating regulations. Each authorization request sent by an agent to a processor must include the AUAR. Each AUAR can be unique based on the algorithm used to calculate AUAR. The transaction handler 106 can validate the AUAR to assure that the agent that calculated and sent the AUAR is registered by the merchant's acquirer.

The AUAR is twelve bytes long and composed of three distinct sub fields:

1—A Length Byte

2—The 5 byte Agent Unique Identifier

3—The least significant 6 bytes (48 binary bits) from the resultant of the HMAC-SHA1 calculation 132. Code to calculate the HMAC-SHA1 is available on public websites listed below.

The agent can transmit the AUAR to the acquiring processor in the format specified by the acquiring processor. The agent must check with the acquiring processor for the specifications for the AUAR. Each sub-field is described below.

Sub-field 1: Length Byte—Byte 1, the most significant byte in the AUAR, can be set to 1. Sub-field 2: Agent Unique Identifier—Bytes 2-6 of the AUAR must be set to the 5 character Agent Unique Identifier provided to the agent by transaction handler 106. Sub-field 3: Resultant of the HMAC-SHA1 Algorithm—Bytes 7-12 of the AUAR must be set to the least significant 48 bits 136 of the resultant 132 of the HMAC-SHA1 algorithm 134. This sub-field must be sent to the acquiring processor in binary format, exactly as produced by the HMAC-SHA1 algorithm. The acquiring processor must transmit this sub-field exactly as provided by the agent.

In the present implementation, HMAC-SHA1 for TAP requires 2 ASCII inputs: 1) A multi-byte data value. This 21 character data value called the Agent Unique Raw Result (AURR) 138 is unique for each authorization request and is composed of two pieces of data: a) the 5-character Agent Unique Identifier provided to the agent by transaction handler 106; b) the 16 digit account number for the authorization request. The multi-byte data value is assembled by appending the 16 digit account number for the transaction to the 5 digit Agent Unique Identifier. AURR (138)={Agent Unique Identifier|Account Number}. 2) A multi-byte key value. This 16 character key value is provided to each agent by the transaction handler 106 as the Secret Code. Each agent can receive a unique, randomly generated Secret Code from transaction handler 106. The Secret Code is composed of upper and lower case letters and decimal digits and must be used in the exact form supplied to the agent by transaction handler 106.

The output of HMAC-SHA-1 is a Message Authentication Code. FIG. 6 illustrates the calculation and construction of AUAR. FIG. 7 contains test vectors with inputs and predicted outputs for the HMAC-SHA1 algorithm. Agents may test their code with these inputs to validate that the agent's implementation of AUAR is correct prior to using the algorithm in production. In addition to the test cases supplied in FIG. 7, there are further test cases available publicly. Please note that these publicly available test cases only validate the functionality of the HMAC-SHA1 calculation and do not include the data to calculate the complete AUAR.

Location of Primary Account Number—Tracks 1 and 2

In one implementation, and referring more particularly to FIG. 8, primary Account Number (PAN) 130 is resident on both tracks 1 and 2 of the card's 112 magnetic stripe. The stripe can be read at the merchant location in card present transactions. Agents must be able to extract the PAN for use in the calculation of Agent Unique Account Result (AUAR). FIG. 8 displays the location of the PAN on both tracks.

Note that although PANs are most commonly 16 digits, PANs, of 13, 15 and 19 digits exist and must be properly configured for the HMAC-SHA-1 calculation. The PAN can always be followed by the separator 140.

Each PAN length will preferably be configured prior to the calculation as follows: 13 digit PAN—pad the least significant 3 positions with spaces to end up with 16 characters; 15 digit PAN—pad the least significant position with spaces to end up with 16 characters; 16 digit PAN—use as extracted from the track, all 16 digits must be used; 19 digit PAN—use the higher order 16 digits of the PAN, drop the use of the least significant 3 digits.

Agents servicing clients that request authorizations for card not present transactions, may need to use the configurations noted above.

It should be understood implementations can be in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method comprising:
receiving, from a third party agent, an authorization request for a transaction in a payment processing network, wherein the authorization request includes:
a bank identification number (BIN) licensed to an acquirer; and
an agent unique account result (AUAR) for the third party agent;
determining a first result of whether the AUAR is:
valid by deriving therefrom:
a primary account number (PAN) corresponding to an account of a consumer conducting the transaction with a merchant; and
an agent identifier that is unique within the payment processing network to other said agent identifiers respectively corresponding to other said third party agents;
invalid by determining that:
the PAN lacked correspondence to the account of the consumer conducting the transaction with the merchant; or
the agent identifier lacked uniqueness within the payment processing network to other said agent identifiers respectively corresponding to other said third party agents;
and
determining a second result of whether the third party agent is registered to use the BIN by locating the agent identifier within a registration set containing a plurality of said agent identifiers each of which has a status of being registered to use the BIN.

2. The method as defined in claim 1, further comprising determining a third result of whether the agent identifier is:
valid by determining the agent identifier is within a set of said agent identifiers; and
invalid by determining the agent identifier is not within the set of said agent identifiers.

3. The method as defined in claim 2, further comprising addressing a transmission for delivery to the acquirer upon the occurrence of an event, the transmission including an identification of the third party agent and the BIN, wherein the event is selected from the group consisting of:
determining the first result that the AUAR is invalid;
determining the second result that the third party agent is not registered to use the BIN; and
determining the third result that the agent identifier is invalid.

4. The method as defined in claim 1, wherein when the third party agent is not registered to use the BIN, the transmission further includes information that the third party agent is not registered to use the BIN.

5. The method as defined in claim 2, further comprising addressing a transmission for delivery to the acquirer upon the occurrence of an event, the transmission including an identification of the merchant, wherein the event is selected from the group consisting of:
determining the result that the AUAR is invalid;
determining the result that the third party agent is not registered to use the BIN; and
determining the result that the agent identifier is invalid.

6. The method as defined in claim 5, wherein the transmission further includes a request to associate the merchant with the plurality of said agent identifiers each of which has the status of being registered to use the BIN.

7. The method as defined in claim 1, further comprises the step of deriving the AUAR substantially from a HMAC-SHA1 algorithm.

8. The method as defined in claim 1, wherein the third party agent being registered to use the BIN further is compliant with a data security standard.

9. The method as defined in claim 1, wherein:
the payment processing network includes a transaction handler processing a plurality of said transactions each characterized by one said merchant and one said consumer conducting the transaction upon one said account issued by an issuer to the one said consumer;
the one said merchant submits the transaction to one said third party agent, the one said third party agent using one said BIN registered to one said acquirer to submit the transaction for processing by the transaction handler who requests the issuer to obtain payment for the transaction; and
the issuer forwards a payment for the transaction to the transaction handler who forwards the payment to the one said third party agent to pay the one said merchant for the transaction.

10. A method of identifying a third party agent submitting an authorization request for a transaction to a payment processing network using a bank identification number (BIN) licensed to an acquirer, the method comprising:
sending a request to the third party agent to return an agent unique account result (AUAR);
receiving, from the third party agent, the AUAR;
determining a first result of whether the AUAR is:
valid by deriving therefrom:
a primary account number (PAN) corresponding to an account of a consumer involved in the transaction with a merchant; and
the agent identifier;
an agent identifier that is included in a registry having a plurality of said agent identifiers each unique to other said agent identifiers and each associated with one said third party agent;
invalid by determining that:
the PAN lacked correspondence to the account of the consumer conducting the transaction with the merchant; or
the agent identifier is not included in the registry;
and
determining a second result of whether the agent identifier is:
valid by determining the agent identifier is within the registry; and
invalid by determining the agent identifier is not within the registry.

11. The method as defined in claim 10, further comprising determining a third result of whether the third party agent is:
registered to use the BIN by determining that the agent identifier has a status of being registered to use the BIN;
not registered to use the BIN by determining that:
the agent identifier is not included in the registry; or
the agent identifier does not have the status of being registered to use the BIN.

12. The method as defined in claim 11, further comprising addressing a transmission for delivery to the acquirer upon the occurrence of an event, the transmission including an identification of the third party agent and the BIN, wherein the event is selected from the group consisting of:
determining the first result that the AUAR is invalid;
determining the second result that the agent identifier is invalid;
and
determining the third result that the third party agent is not registered to use the BIN.

13. The method as defined in claim 12, further comprising sending the notification periodically.

14. The method as defined in claim 12, wherein the third party agent is not registered to use the BIN, the transmission further includes information that the third party agent is not registered to use the BIN.

15. The method as defined in claim 12, wherein the third party agent is not registered to use the BIN, the transmission further includes identification of the merchant.

16. The method as defined in claim 15, wherein the transmission further includes a request to associate the merchant with the one said agent identifier having the status of being registered to use the BIN.

17. The method as defined in claim 10, wherein the plurality of said agent identifiers included in the registry are each associated with one said third party agent that is compliant with a data security standard.

18. The method as defined in claim 10, further comprising the step of deriving the AUAR substantially from a HMAC-SHA1 algorithm.

19. The method as defined in claim 10, wherein:
the payment processing network includes a transaction handler processing a plurality of said transactions each characterized by one said merchant and one said consumer conducting the transaction upon one said account issued by an issuer to the one said consumer;
the one said merchant submits the transaction to one said third party agent, the one said third party agent using one said BIN registered to one said acquirer to submit the transaction for processing by the transaction handler who requests the issuer to obtain payment for the transaction; and
the issuer forwards a payment for the transaction to the transaction handler who forwards the payment to the one said third party agent to pay the one said merchant for the transaction.

20. In a payment processing network that includes a transaction handler processing a plurality of transactions each characterized by a merchant and a consumer engaging in the transaction upon an account associated by a payment device that an issuer issues to the consumer, wherein the merchant submits the transaction to a third party agent, the third party agent using a bank identification number (BIN) registered an acquirer, to submit the transaction for processing by the transaction handler who requests the issuer to obtain payment for the transaction, and wherein the issuer forwards the payment to the transaction handler who forwards the payment to the third party agent to pay the merchant for the transaction, a method comprising:
sending a request to the to the transaction handler to transmit an agent unique account result (AUAR) with each of the plurality of transactions, the AUAR being a number calculated by the third party agent, or if the third party agent does not calculate the number, the AUAR being a reserved number;
receiving, from the transaction handler, the AUAR;
determining a first result of whether the AUAR is:
valid by deriving therefrom:
a primary account number (PAN) corresponding to an account of a consumer involved in the transaction with a merchant; and
the agent identifier;
an agent identifier that is included in a registry having a plurality of said agent identifiers each unique to other said agent identifiers and each associated with one said third party agent;
invalid by determining that:
the AUAR is the reserved number;
the PAN lacked correspondence to the account of the consumer conducting the transaction with the merchant; or
the agent identifier is not included in the registry;
and
determining a second result of whether the agent identifier is:
valid by determining the agent identifier is within the registry; and
invalid by determining the agent identifier is not within the registry.

21. The method as defined in claim 20, further comprising determining a third result of whether the third party agent is:
registered to use the BIN by determining that the agent identifier has a status of being registered to use the BIN;
not registered to use the BIN by determining that:
the agent identifier is not included in the registry; or
the agent identifier does not have the status of being registered to use the BIN.

22. The method as defined in claim 21, further comprising addressing a transmission for delivery to the acquirer upon the occurrence of an event, the transmission including an identification of the third party agent and the BIN, wherein the event is selected from the group consisting of:
determining the first result that the AUAR is invalid;
determining the second result that the agent identifier is invalid;
and
determining the third result that the third party agent is not registered to use the BIN.

23. The method as defined in claim 22, further comprising sending the notification periodically.

24. The method as defined in claim 22, wherein the third party agent is not registered to use the BIN, the transmission further includes information that the third party agent is not registered to use the BIN.

25. The method as defined in claim 22, wherein the third party agent is not registered to use the BIN, the transmission further includes:
identification of the merchant; and
a request to associate the merchant with the one said agent identifier having the status of being registered to use the BIN.

26. The method as defined in claim 22, further comprising the step of deriving the AUAR substantially from a HMAC-SHA1 algorithm.

27. In a payment processing system that includes a transaction handler processing a plurality of transactions each characterized by a merchant and a consumer engaging in a transaction of the plurality of transactions upon an account that an issuer has issued to the consumer, wherein the merchant submits the transaction to an acquirer for processing by the transaction handler who requests the issuer to obtain payment for the transaction from the consumer, and wherein the issuer forwards the payment to the transaction handler who forwards the payment to the acquirer to pay the merchant for the transaction, a computer implemented method comprising the steps of:
establishing a registry for third party agents who are compliant with a security measure;
assigning an agent unique identifier and a secret code to a third party agent when it is compliant with the security measure;
requiring the use of the third party agent unique identifier and a secret code along with a primary account number for the transaction;
identifying an agent unique account result from the agent unique identifier and the secret code;
requesting that the third party agent transmit the agent unique account result in any authorization request messages sent to an acquiring processor;
obligating the acquiring processor to include the agent unique account result in the authorization request messages that have been sent to the acquiring processor by the third party agent;
storing the authorization request messages; and
periodically reporting to the acquirer all acquiring processors using any bank identification numbers associated with the acquirer that the acquirer has not designated the acquiring processor to use, and all agents using the acquirer bank identification numbers that such agents are not registered in the registry.

28. The method as defined in claim 27, further including the step of providing the acquiring processor with a reserved agent unique account result that indicates an agent has submitted an authorization request absent the agent unique account result.

29. The method of claim 28, further including the step of requiring the acquiring processor to place the reserved agent unique account result into the authorization request when the agent does not supply an agent unique account result.

30. The method as defined in claim 27, further including the step of notifying the acquirer of unauthorized use of its bank identification numbers by acquiring processors and agents on a periodic basis.

31. The method as defined in claim 27, further including the step of necessitating the acquirer to one of a) sponsor the acquiring processor and register the agent, and b) move the merchant to a registered agent from the registry.

32. The method as defined in claim 27, wherein the requiring step includes the requirement of calculating the agent unique account result for the third party agent using an HMAC-SHA1 algorithm, and the agent unique identifier and the secret code.

33. The method as defined in claim 27, wherein the method is performed at least in part by instructions executed by a computer, wherein the instructions are part of a computer readable medium.
